(19) United States
(12) Patent Application Publication
(10) Pub. No.: US 2026/0097350 A1
(43) Pub. Date: Apr. 9, 2026

(54) HONEYCOMB FILTERS COMPRISING ACTIVATED CARBON AND METHODS OF MAKING THE SAME

(71) Applicant: CORNING INCORPORATED, CORNING, NY (US)

(72) Inventors: Catherine Michelle Anne Burdick, Lindley, NY (US); Kishor Purushottam Gadkaree, Painted Post, NY (US); Andrew Fleitz Husted, Wellsburg, NY (US); Rahul Suryakant Kadam, Big Flats, NY (US)

(21) Appl. No.: 19/103,962

(22) PCT Filed: Sep. 18, 2023
(86) PCT No.: PCT/US2023/033015

§ 371 Date: Feb. 14, 2025

Related U.S. Application Data
(60) Provisional application No. 63/410,760, filed on Sep. 28, 2022.

(51) Int. Cl. B01D 53/04; B01J 20/20; B01J 20/28; B01J 20/30

(52) U.S. Cl. CPC B01D 53/04; B01J 20/20; B01J 20/28045; B01J 20/3078; B01D 2253/102; B01D 2253/3425; B01D 2257/504

(57) ABSTRACT

According to embodiments described herein, a honeycomb filter may include a porous honeycomb body including activated carbon, wherein the activated carbon may be dispersed throughout porous channel walls of the porous honeycomb body and the activated carbon may include from 1 wt. % to 50 wt. % nitrogen. A method of making the honeycomb filter may include forming a shapable honeycomb precursor composition including a cross-linked resin, shaping the honeycomb precursor composition to form a honeycomb green body, heat treating the honeycomb green body, and activating the carbonized honeycomb green body. Another method of making the honeycomb filter may include forming a honeycomb precursor composition including a cross-linked resin, heat treating the honeycomb precursor composition, activating the carbonized honeycomb precursor composition, and shaping the activated honeycomb precursor composition. The cross-linked resin may include from 0.5 wt. % to 4 wt. % nitrogen.

### CROSS-REFERENCE TO RELATED APPLICATIONS

This application claims the benefit of priority under 35 U.S.C. § 119 of U.S. Provisional Application No. 63/410,760 filed Sep. 28, 2022, the content of which is incorporated herein by reference in its entirety.

### TECHNICAL FIELD

Embodiments of the present disclosure generally relate to separation devices. More specifically, embodiments of the present disclosure relate to filters and methods of making filters.

### BACKGROUND

Greenhouse gas emissions have been linked to the increase in the average global temperature and pose potential harmful effects on the ecosystem. Further, due at least partially to the burning of fossil fuels, large amount of carbon dioxide emissions are contributing to the greenhouse gas effect. Therefore, capture of carbon dioxide is being investigated around the world in order to mitigate the amount of these greenhouse gases that enter the atmosphere. One such way to capture carbon dioxide is by filtering process gases that include carbon dioxide. Accordingly, improved filters that can capture carbon dioxide are needed.

### SUMMARY

According to one embodiment described herein, a honeycomb filter may comprise a porous honeycomb body comprising activated carbon, the porous honeycomb body having a plurality of parallel cell channels bounded by porous channel walls traversing the porous honeycomb body from an upstream inlet end to a downstream outlet end, wherein: the activated carbon is dispersed throughout the porous channel walls; and the activated carbon comprises from 1 wt. % to 50 wt. % nitrogen based on the total weight of the activated carbon.

According to another embodiment described herein, a method of making a honeycomb filter may comprise forming a shapable honeycomb precursor composition comprising a cross-linked resin, wherein the cross-linked resin comprises from 0.5 wt. % to 4 wt. % nitrogen based on the total weight of the cross-linked resin; shaping the honeycomb precursor composition to form a honeycomb green body having a plurality of parallel cell channels bounded by porous channel walls traversing the honeycomb green body from an upstream inlet end to a downstream outlet end; heat treating the honeycomb green body to carbonize the cross-linked resin and form a carbonized honeycomb green body; and activating the carbonized honeycomb green body to produce the honeycomb filter comprising an activated carbon honeycomb body having a plurality of parallel cell channels bounded by porous channel walls traversing the body from an upstream inlet end to a downstream outlet end, wherein the activated carbon honeycomb body comprises activated carbon comprising from 1 wt. % to 50 wt. % nitrogen based on the total weight of the activated carbon.

According to yet another embodiment described herein, a method of making a honeycomb filter may comprise forming a honeycomb precursor composition comprising a cross-linked resin, wherein the cross-linked resin comprises from 0.5 wt. % to 4 wt. % nitrogen based on the total weight of the cross-linked resin; heat treating the honeycomb precursor composition to carbonize the cross-linked resin and form a carbonized honeycomb precursor composition; activating the carbonized honeycomb precursor composition to produce an activated honeycomb precursor composition; and shaping the activated honeycomb precursor composition to form the honeycomb filter comprising an activated carbon honeycomb body having a plurality of parallel cell channels bounded by porous channel walls traversing the body from an upstream inlet end to a downstream outlet end, wherein the activated carbon honeycomb body comprises activated carbon comprising from 1 wt. % to 50 wt. % nitrogen based on the total weight of the activated carbon.

Additional features and advantages of the embodiments described herein are set forth in the detailed description, the claims, and the appended drawing.

The foregoing general description and the following detailed description provide various embodiments and provide an overview or framework for understanding the nature and character of the claimed subject matter. The accompanying drawing provides a further understanding of the various embodiments, and are incorporated into and constitute a part of this specification. The drawing and the description explain the principles and operations of the claimed subject matter.

### BRIEF DESCRIPTION OF THE DRAWING

The following detailed description of specific embodiments of the present disclosure can be best understood when read in conjunction with the following drawing, where like structure is indicated with like reference numerals and in which:

FIG. 1 is a perspective view of a honeycomb filter, according to one or more embodiments as described herein.

Reference will now be made in greater detail to various embodiments, some embodiments of which are illustrated in the accompanying drawing. Whenever possible, the same reference numerals will be used throughout the drawing to refer to the same or similar parts.

### DETAILED DESCRIPTION

References will now be made in greater detail to various embodiments. The present disclosure is directed to honeycomb filters that may comprise activated carbon. Such honeycomb filters may be operable to capture carbon dioxide in process gas streams, such as automobile exhaust streams. As is described in detail herein, the honeycomb filters may include porous walls, and process gas may be passed through the porous walls, causing at least some carbon dioxide to be separated from the process gas stream.

According to embodiments described herein, the honeycomb filters may comprise activated carbon, where the activated carbon comprises a relatively high nitrogen content (e.g., at least 1 wt. % nitrogen). It has been discovered that the use of such activated carbon with a relatively high nitrogen content may increase the honeycomb filter's adsorption capability of carbon dioxide. Such filters, as well as methods for making and using such filters are described in detail herein.

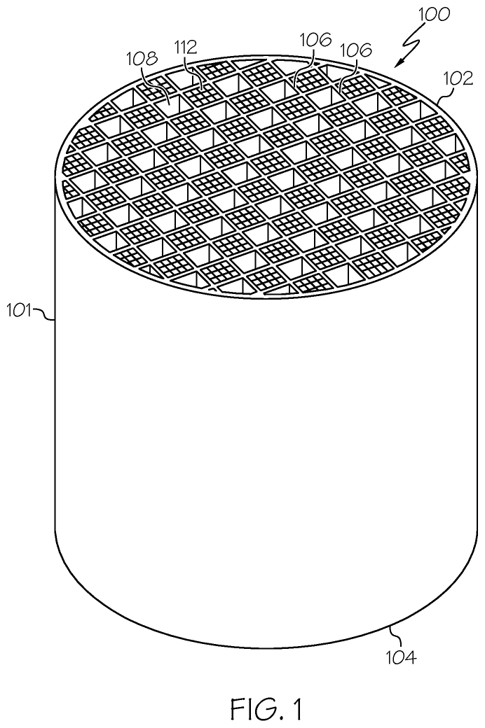

Referring to FIG. 1, a honeycomb filter 100 is shown having a porous honeycomb body 101 having an inlet end 102, an outlet end 104, and a plurality of parallel cell channels 108 extending from the inlet end 102 to the outlet end 104, where the cell channels 108 are bounded by porous channel walls 106 traversing from the inlet end 102 to the outlet end 104. In one or more embodiments, the porous channel walls 106 may be configured so that the cell channels 108 have any cross-sectional shape, such as, but not limited to, a square, a circle, an oval, a hexagon, or a triangle cross-sectional shape. In one or more embodiments, the majority to all of the cell channels 108 may have the same or similar cross-sectional shape and each cell channel 108 may share one or more porous channel walls 106 with an adjacent cell channel 108, such that one cell channel 108 is parallel or near parallel to an adjacent cell channel 108, where this pattern may be repeated throughout the honeycomb filter 100.

In one or more embodiments, one or more of the cell channels 108 of the honeycomb filter 100 may have a plug 112. In some embodiments, the plug 112 present on the one or more cell channels 108 of the honeycomb filter 100 may be placed at or near the inlet end 102 of the one or more cell channels 108 that are plugged. In some embodiments, a portion of the cell channels 108 on the outlet end 104, but not corresponding to those on the inlet end 102, may also be plugged in a similar pattern. In some embodiments, each cell channel 108 is plugged only at one end. In some embodiments, the cell channels 108 are arranged to have every other cell on a given face plugged as in a checkered pattern as further shown in FIG. 1.

It will be appreciated that this plugging configuration allows for intimate contact between a fluid process stream and the porous channel walls 106 of the honeycomb filter 100. The fluid process stream may flow into the honeycomb filter 100 through the open cell channels 108 at the inlet end 102, then through the porous cell walls 106, and out of the porous honeycomb body 101 through the open cells at the outlet end 104. The honeycomb filters 100, as described herein, may be known as “wall flow” structures since the flow paths resulting from alternate channel plugging require the fluid process stream being treated to flow through the porous channel walls 106 prior to exiting the porous honeycomb body 101. In one embodiment, the percentage of open cell channels 108 of a honeycomb filter 100 in comparison to the total number of cell channels 108 may be from 10% to 90%, such as from 20% to 90%, from 30% to 90%, from 40% to 90%, from 50% to 90%, from 60% to 90%, from 70% to 90%, from 80% to 90%, from 20% to 80%, from 30% to 70%, or from 40% to 60%.

In one or more embodiments, the porous honeycomb body 101 may comprise activated carbon. As described herein, activated carbon may refer to carbon-containing compositions that contain small, low-volume pores and a relatively high surface area that are operable to adsorb one or more contaminants. As described herein, activated carbon may comprise, in addition to carbon atoms, other atoms, such as nitrogen. Generally, the nitrogen may be bonded to the carbon atoms in the activated carbon.

In one or more embodiments, the activated carbon may be dispersed throughout at least the porous channel walls 106 of the porous honeycomb body 101, where the activated carbon may be dispersed throughout the entirety, or near entirety, of the porous honeycomb body 101. As described herein, the activated carbon being dispersed throughout at least a portion of the porous channel walls 106 and/or the porous honeycomb body 101 may refer to the activated carbon being well-distributed throughout the entirety, or near entirety, of the solid porous channel walls 106 and/or the porous honeycomb body 101 structures, as opposed to having the activated carbon being deposited on just one or more surfaces of the porous channel walls 106 and/or the porous honeycomb body 101. For example, and as is described in detail herein, the activated carbon may be dispersed throughout the body 101 by the body 101 being formed by a material that has a relatively uniform distribution of activated carbon, or a precursor to an activated carbon.

In one or more embodiments, the activated carbon may comprise nitrogen. In one or more embodiments, the activated carbon of the porous honeycomb body 101 may comprise from 1 wt. % to 50 wt. % nitrogen based on the total weight of the activated carbon. For example, in one or more embodiments, the activated carbon of the porous honeycomb body 101 may comprise from 1 wt. % to 50 wt. % nitrogen, from 5 wt. % to 50 wt. % nitrogen, from 7.5 wt. % to 50 wt. % nitrogen, from 10 wt. % to 50 wt. % nitrogen, from 12.5 wt. % to 50 wt. % nitrogen, from 15 wt. % to 50 wt. % nitrogen, from 20 wt. % to 50 wt. % nitrogen, from 25 wt. % to 50 wt. % nitrogen, from 35 wt. % to 50 wt. % nitrogen, from 1 wt. % to 40 wt. % nitrogen, from 1 wt. % to 30 wt. % nitrogen, from 1 wt. % to 20 wt. % nitrogen, from 1 wt. % to 10 wt. % nitrogen, from 5 wt. % to 45 wt. % nitrogen, from 10 wt. % to 45 wt. % nitrogen, from 15 wt. % to 45 wt. % nitrogen, from 20 wt. % to 45 wt. % nitrogen, or from 25 wt. % to 40 wt. % nitrogen based on the total weight of the activated carbon.

Without being bound by any particular theory, it is believed that the relatively high nitrogen content (e.g., at least 1 wt. %) of the activated carbon may result in an increased adsorption of one or more molecules of a gas stream that may be passed through the honeycomb filter 100 when compared to conventional filters that do not utilize nitrogen-containing activated carbons. In particular, it is believed that the activated carbon dispersed throughout the porous channel walls 106 of the honeycomb filter 100 will allow nitrogen atoms of the activated carbon to better bond with one or more molecules of a gas stream that passes through the pores of the porous channel walls 106. In one or more embodiments, the nitrogen may be effective to adhere carbon dioxide gases.

Further, it is believed that the honeycomb filter structure that has a body having the activated carbon comprising from 1 wt. % to 50 wt. % nitrogen dispersed throughout allows for the gas to have intimate contact with the activated carbon activated carbon comprising from 1 wt. % to 50 wt. % nitrogen, thus increasing the adsorption of one or more molecules of a gas stream that is passed through the filter, when compared to conventional filters that do not form a filter body having a nitrogen-containing compound dispersed throughout. The porous honeycomb bodies as described throughout are formed from nitrogen-containing compounds and resins, such that the body of the honeycomb filter 100 has the activated carbon activated carbon comprising from 1 wt. % to 50 wt. % nitrogen dispersed throughout. Hence, this may also result in the honeycomb filters 100 achieving a longer lasting ability to adsorb one or more molecules of a gas stream, such as carbon dioxide, since the nitrogen atoms will remain intact throughout the porous honeycomb body 101 after multiple regeneration cycles than when compared to conventional filters that may deposit nitrogen-containing compounds onto the surface of the filter, where these deposits will erode after multiple regeneration cycles. Additionally, having the porous honeycomb body 101 having the activated carbon activated carbon comprising from 1 wt. % to 50 wt. % nitrogen being dispersed throughout allows this filter to remove the adsorbed materials through electrical regeneration, which can allow the filter to go through more cycles of regeneration and result in a longer lasting filter than filters that have to go through other conventional regeneration processes.

The activated carbon as described herein may comprise a total carbon content in the range of from 10 wt. % to 50 wt. % relative to the total weight of the activated carbon, such as, for example, a total carbon content of from 15 wt. % to 50 wt. %, from 20 wt. % to 50 wt. %, from 25 wt. % to 50 wt. %, from 30 wt. % to 50 wt. %, from 35 wt. % to 50 wt. %, from 40 wt. % to 50 wt. %, from 10 wt. % to 45 wt. %, from 10 wt. % to 40 wt. %, from 10 wt. % to 35 wt. %, from 10 wt. % to 30 wt. %, from 10 wt. % to 25 wt. %, from 10 wt. % to 20 wt. %, from 15 wt. % to 45 wt. %, from 20 wt. % to 40 wt. %, or from 25 wt. % to 35 wt. % relative to the total weight of the activated carbon.

The honeycomb filters 100 as described herein may be further characterized according to the pore microstructure and nanostructure of the honeycomb filter bodies. In one or more embodiments, the porous honeycomb body 101, including the porous channel walls 106, may include micropores (e.g., pores having a diameter of from 0.1 μm to 150 μm) and/or nanopores (e.g., pores having a diameter of from 0.01 nm to 100 nm). The pores of the honeycomb filter bodies may be characterized as “interconnecting”, such that pores connect into and/or intersect other pores to create a tortuous network of porosity within the substrate. As will be appreciated by one of ordinary skill on the art, the interconnecting pores can help to reduce undesirable levels of backpressure that can form when a fluid process stream is passed through the honeycomb filter 100.

In one or more embodiments, the porous honeycomb body 101 may have a cell channel density of from 5 cell channels to 900 cell channels per square centimeter. For example, the porous honeycomb body 101 may have a cell channel density of from 10 cell channels to 900 cell channels, from 50 cell channels to 900 cell channels, from 100 cell channels to 900 cell channels, from 200 cell channels to 900 cell channels, from 300 cell channels to 900 cell channels, from 400 cell channels to 900 cell channels, from 500 cell channels to 900 cell channels, from 5 cell channels to 750 cell channels, from 5 cell channels to 500 cell channels, from 5 cell channels to 400 cell channels, from 5 cell channels to 300 cell channels, from 5 cell channels to 200 cell channels, from 50 cell channels to 700 cell channels, from 150 cell channels to 500 cell channels, or from 200 cell channels to 400 cell channels per square centimeter.

In one or more embodiments, the porous channel walls 106 of the cell channels 108 may have an average wall thickness of from 0.001 centimeters to 0.15 centimeters. For example, the porous channel walls 106 of the cell channels 108 may have an average wall thickness of from 0.005 centimeters to 0.15 centimeters, from 0.01 centimeters to 0.15 centimeters, from 0.05 centimeters to 0.15 centimeters, from 0.1 centimeters to 0.15 centimeters, from 0.001 centimeters to 0.1 centimeters, from 0.001 centimeters to 0.05 centimeters, from 0.001 centimeters to 0.01 centimeters, or from 0.001 centimeters to 0.005 centimeters.

In one or more embodiments, the honeycomb filter bodies as described herein may have a surface area of from 750 m²/g to 2,500 m²/g. For example, the honeycomb filter bodies may have a surface area of from 1,000 m²/g to 2,500 m²/g, from 1,250 m²/g to 2,500 m²/g, from 1,500 m²/g to 2,500 m²/g, from 1,750 m²/g to 2,500 m²/g, from 2,000 m²/g to 2,500 m²/g, from 2,250 m²/g to 2,500 m²/g, from 750 m²/g to 2,250 m²/g, from 750 m²/g to 2,000 m²/g, from 750 m²/g to 1,750 m²/g, from 750 m²/g to 1,500 m²/g, from 750 m²/g to 1,225 m²/g, from 750 m²/g to 1,000 m²/g, from 1,000 m²/g to 2,000 m²/g, or from 1,250 m²/g to 1,775 m²/g.

According to additional embodiments, carbon dioxide may be adsorbed by passing a gas comprising carbon dioxide through one or more of the plurality of parallel channels of the honeycomb filter 100. In such embodiments, at least a portion of the gas passes through one or more of the porous channel walls and at least a portion of the carbon dioxide from the gas is adsorbed onto the one or more porous channel walls. As described herein, adsorbing may refer to when one or more molecules within the gas, such as carbon dioxide, bonds to at least a portion of the honeycomb filter 100, where the one or more molecules within the gas, such as carbon dioxide, bonds with the nitrogen atoms of the activated carbon.

As described herein, the honeycomb filters 100 as described in the present application may be formed by various methods. According to one or more embodiments, a method of making the honeycomb filter 100 may comprise forming a shapable honeycomb precursor composition comprising a cross-linked resin, shaping the honeycomb precursor composition to form a honeycomb green body, heat treating the honeycomb green body to carbonize the cross-linked resin and form a carbonized honeycomb green body, and activating the carbonized honeycomb green body to produce the honeycomb filter 100 comprising an activated carbon honeycomb body.

According to additional embodiments, a method of making the honeycomb filter 100 may comprise forming a honeycomb precursor composition comprising a cross-linked resin, heat treating the honeycomb precursor composition to carbonize the cross-linked resin and form a carbonized honeycomb precursor composition, activating the carbonized honeycomb precursor composition to produce an activated honeycomb precursor composition, and shaping the activated honeycomb precursor composition to form the honeycomb filter 100 comprising an activated carbon honeycomb body.

According to additional embodiments, a method of making the honeycomb filter 100 may comprise forming a honeycomb precursor composition comprising a cross-linked resin, heat treating the honeycomb precursor composition to carbonize the cross-linked resin and form a carbonized honeycomb precursor composition, shaping the carbonized honeycomb precursor composition to form a shaped carbonized honeycomb precursor composition having a body, and activating the shaped carbonized honeycomb precursor composition to produce the honeycomb filter 100 having an activated carbon honeycomb body.

As used herein, a cross-linked resin refers to a polymeric carbon-containing substance that converts to a continuous structure carbon upon heating. In one embodiment, the cross-linked resin may be a synthetic resin in the form of a solution or low viscosity liquid at ambient temperatures. Alternatively, the cross-linked resin may be a solid at ambient temperature and capable of being liquefied by heating or other means. Thus, as used herein, cross-linked resins include any liquid or liquefiable carbonaceous substances. Examples of cross-linked resins include thermosetting resins and thermoplastic resins (e.g., polyvinylidene chloride, polyvinyl chloride, polyvinyl alcohol, and the like). Still further, in one embodiment, relatively low viscosity cross-linked resins (e.g., thermosetting resins) may have viscosity ranges from about 50 to 100 centipoise. In additional embodiments, any high carbon yield resin can be used. As used herein, high carbon yield is meant that greater than about 10% of the starting weight of the resin is converted to carbon upon carbonization.

In one or more embodiments, the cross-linked resin may be one or more nitrogen-containing resins. For example, in one or more embodiments, the cross-linked resin may be a resin comprising cross-linked nitrogen-containing polymer chains where the nitrogen-containing polymer chains are formed through the polymerization of a nitrogen-containing compound such as, for example, aminophenol, nitrophenol, melamine, and/or primary, secondary, tertiary amines (e.g., linear polyethylenimine, branched polyethylenimine, crosslinked polyethylenimine, etc.). For example, in one embodiment, aminophenol may be combined with one or more reactants, such as formaldehyde, to form nitrogen-containing polymer chains, where the nitrogen-containing polymer chains further interact and crosslink to produce an aminophenol-based resin. In another example, melamine may be combined with one or more reactants, such as formaldehyde, to form nitrogen-containing polymer chains, where the nitrogen-containing polymer chains further interact and crosslink to produce a melamine-based resin. It is to be understood that the nitrogen-containing compound may combine and react with various other reactants along with one or more solvents at various operating conditions that result in different cross-linking patterns of the formed crosslinked polymer chains of the cross-linked resins.

In one or more embodiments, the cross-linked resin may comprise from 0.5 wt. % to 4 wt. % nitrogen based on the total weight of the cross-linked resin. For example, the cross-linked resin may comprise from 0.5 wt. % to 3.5 wt. % nitrogen, from 0.5 wt. % to 3 wt. % nitrogen, from 0.5 wt. % to 2.5 wt. % nitrogen, from 0.5 wt. % to 2 wt. % nitrogen, from 0.5 wt. % to 1.5 wt. % nitrogen, from 1 wt. % to 4 wt. % nitrogen, from 1.5 wt. % to 4 wt. % nitrogen, from 2 wt. % to 4 wt. % nitrogen, from 2.5 wt. % to 4 wt. % nitrogen, from 3 wt. % to 4 wt. % nitrogen, from 1 wt. % to 3 wt. % nitrogen, or from 1.5 wt. % to 2.5 wt. % nitrogen based on the total weight of the cross-linked resin.

In another embodiment, the cross-linked resin may comprise a phenolic resin or furan resin. Phenolic resins may have low viscosity, high carbon yield, and high degree of cross-linking upon curing relative to other precursors and may have a relatively low cost. Examples of phenolic resins may be resole resin such as 43250 plyophen resin, 43290 from Occidental Chemical Corporation, and Durite resole resin from Borden Chemical Company. An example furan liquid resin is Furcab-LP from QO Chemicals Inc. An example solid resin may be a solid phenolic resin or novolak.

The honeycomb precursor composition comprising the cross-linked resin may optionally be mixed with one or more binders, fillers, and/or forming aids. A binder refers to a material used to form materials into a cohesive whole, as a means of providing structural stability. A filler refers to particles added to resins or binders (e.g., plastics, composites, concrete) that can improve specific properties of the overall composition. A forming aid may refer to any additive that is added to a resin to help facilitate processing of the resin. Binders that may be used are plasticizing temporary organic binders such as cellulose ethers. Typical cellulose ethers include methylcellulose, ethylhydroxy ethylcellulose, hydroxy butylcellulose, hydroxy butyl methylcellulose, hydroxyethylcellulose, hydroxymethylcellulose, hydroxypropylcellulose, hydroxypropyl methylcellulose, hydroxyethyl methylcellulose, sodium carboxy methylcellulose, and mixtures thereof. Further, methylcellulose and/or methylcellulose derivatives may be used along with methylcellulose, hydroxypropyl methylcellulose, or combinations of these.

Fillers that may also be used in the honeycomb precursor composition include both natural and synthetic, hydrophobic and hydrophilic, fibrous and nonfibrous, and carbonizable and non-carbonizable fillers. For example, some natural fillers may be soft woods, e.g. pine, spruce, redwood, etc., hardwoods, e.g. ash, beech, birch, maple, oak, etc., sawdust, shell fibers, e.g. ground almond shell, coconut shell, apricot pit shell, peanut shell, pecan shell, walnut shell, etc., cotton fibers, e.g. cotton flock, cotton fabric, cellulose fibers, cotton seed fiber, chopped vegetable fibers, for example, hemp, coconut fiber, jute, sisal, and other materials such as corn cobs, citrus pulp (dried), soybean meal, peat moss, wheat flour, wool fibers, corn, potato, rice, tapioca, coal powder, activated carbon powder, etc. Some synthetic materials may be regenerated cellulose, rayon fabric, cellophane, etc. In addition, partially or fully cured resin powder may also be added as a carbonizable filler.

Examples of carbonizable fillers may be cellulose, cotton, wood, and sisal, or combinations of these, all of which may be in the form of fibers. One example of a carbonizable fiber filler is cellulose fiber as supplied by International Filler Corporation, North Tonawanda, N.Y. This material has the following sieve analysis: 1-2% on 40 mesh (420 micrometers), 90-95% thru 100 mesh (149 micrometers), and 55-60% thru 200 mesh (74 micrometer).

Inorganic fillers that may be used include oxygen-containing minerals or salts thereof, such as clays, zeolites, talc, etc., carbonates, such as calcium carbonate, alumninosilicates such as kaolin (an aluminosilicate clay), flyash (an aluminosilicate ash obtained after coal firing in power plants), silicates. e.g. wollastonite (calcium metasilicate), titanates, zirconates, zirconia, zirconia spinel, magnesium aluminum silicates, mullite, alumina, alumina trihydrate, boehmite, spinel, feldspar, attapulgites, and aluminosilicate fibers, cordierite powder, etc. Some additional examples of inorganic fillers are cordierite powder, talcs, clays, and aluminosilicate fibers such as provided by Carborundum Co. Niagara Falls, N.Y. under the name of Fiberfax, and combinations of these. Fiberfax aluminosilicate fibers may measure about 2-6 micrometers in diameter and about 20-50 micrometers in length. Additional examples of inorganic fillers are various carbides, such as silicon carbide, titanium carbide, aluminum carbide, zirconium carbide, boron carbide, and aluminum titanium carbide; carbonates or carbonate-bearing minerals such as baking soda, nahcolite, calcite, hanksite and liottite; and nitrides such as silicon nitride.

Hydrophobic organic fillers may also provide additional support to the shaped structure and introduce wall porosity on carbonization because these fillers generally leave relatively little carbon residue. Some hydrophobic organic fillers may be polyacrylonitrile fibers, polyester fibers (flock), nylon fibers, polypropylene fibers (flock) or powder, acrylic fibers or powder, aramid fibers, polyvinyl alcohol, etc.

Additional binders and fillers that may be used in the instant disclosure are disclosed and described in U.S. Pat. No. 5,820,967, the entire disclosure of which is incorporated herein by reference.

Optionally, forming aids, e.g. extrusion aids, may also be included in the honeycomb precursor compositions. To this end, the forming aids may include soaps, fatty acids, such as oleic, linoleic acid, etc., polyoxyethylene stearate, etc. or combinations thereof. In some embodiments, sodium stearate may be used as a forming aid. Optimized amounts of the optional forming aid(s) and/or extrusion aid(s) will depend on the composition and binder. Other additives that may be useful for improving the extrusion and curing characteristics of the honeycomb precursor compositions may be phosphoric acid and oil. Phosphoric acid may improve the cure rate and increases adsorption capacity. It is typically used in about 0.1 wt. % to 5 wt. % in the honeycomb precursor composition mixture.

Further, an oil addition may aid in extrusion and can result in an increase in surface area and porosity. To this end, an optional oil may be added in an amount in the range of from about 0.1 wt. % to 5 wt. % of the honeycomb precursor composition mixture. When used, the oil may be water immiscible, so that it forms a stable emulsion with any liquid polymeric resins. Some example oils that may be used include petroleum oils with molecular weights from about 250 to 1,000 kg/mol, containing paraffinic and/or aromatic and/or alicyclic compounds. When paraffinic oils composed primarily of paraffinic and alicyclic structures are used, these may contain additives such as rust inhibitors or oxidation inhibitors such as are commonly present in commercially available oils. Some useful oils are 3-in-1 oil from 3M Co., or 3-in-1 household oil from Reckitt and Coleman Inc., Wayne, N.J. Other useful oils may include synthetic oils based on poly (alpha olefins), esters, polyalkylene glycols, poly butenes, silicones, polyphenyl ether, CTFE oils, and other commercially available oils. Vegetable oils such as sunflower oil, sesame oil, peanut oil, etc. may also be used. These oils may have a viscosity of about 10 to 300 centipoise. Generally, the amount of activated carbon in the shaped body is about 10 wt. % to 98 wt %.

In order to obtain a desired pore structure, an optional pore-forming agent may be incorporated into the honeycomb precursor compositions. In some embodiments, pore forming agents may include polypropylene, polyester, or acrylic powders or fibers that decompose in inert atmosphere at high temperature (>400° C.) to leave little or no residue. In some embodiments, the pore forming agents can form macropores due to particle expansion. For example, intercalated graphite, which contains an acid like hydrochloric acid, sulfuric acid, or nitric acid, may form macropores when heated, due to the resulting expansion of the acid. Still further, macropores may also be formed by dissolving certain fugitive materials. For example, baking soda, calcium carbonate or limestone particles having a particle size corresponding to desired pore size can be extruded with carbonaceous materials to form the honeycomb green body. Baking soda, calcium carbonate or limestone may form water soluble oxides during the carbonization and activation processes, which can subsequently be leached to form macropores by soaking the honeycomb filter 100 in water.

The honeycomb precursor composition may be shaped to provide a honeycomb body having a plurality of parallel cell channels 108 bounded by porous channel walls 106 traversing the body from an upstream inlet end 102 to a downstream outlet end 104. The precursor composition may be shaped at various stages of the methods of forming the honeycomb filter 100 as described herein, including before heat treating and/or activating the precursor composition, after heat treating the precursor composition but before activating the precursor composition, and after heat treating and activating the precursor composition. The precursor composition may be shaped by any known conventional process, such as, e.g., extrusion, injection molding, slip casting, centrifugal casting, pressure casting, dry pressing, and the like. In one embodiment, extrusion may be done using a hydraulic ram extrusion press, a two stage de-airing single auger extruder, or a twin screw mixer with a die assembly attached to the discharge end. When using a twin screw mixer, the proper screw elements may be chosen according to material and other process conditions in order to build up sufficient pressure to force the precursor composition material through the die.

Heat treating the shaped or unshaped precursor composition may include subjecting the shaped or unshaped precursor composition to heat treatment conditions effective to cure and/or carbonize any cross-linked resin components present in the precursor composition. The curing may generally be performed in air at atmospheric pressures and typically by heating the shaped or unshaped precursor composition at a temperature of about 100° C. to about 200° C. for about 0.5 to about 5.0 hours. Alternatively, when using certain precursors, (e.g., furfuryl alcohol), curing can also be accomplished by adding a curing catalyst such as an acid catalyst at room temperature.

Carbonization refers to the thermal decomposition of the carbonaceous material, thereby eliminating low molecular weight species (e.g., carbon dioxide, water, gaseous hydrocarbons, etc.) and producing a fixed carbon mass and a rudimentary pore structure in the carbon. Such conversion or carbonization of the cross-linked resin is accomplished typically by heating to a temperature in the range of about 600° C. to about 1,200° C. for about 1 to about 10 hours in a reducing or inert atmosphere (e.g., nitrogen, argon, helium, etc.). Carbonizing the cross-linked resin may result in substantially uninterrupted carbon.

The carbonized honeycomb body may then be heat-treated to activate the carbon and produce an activated carbon structure. The activating may be done to enhance the volume and to enlarge the diameter of the micropores formed during carbonization, as well as to create new porosity. Activation may create a high surface area and in turn impart high adsorptive capability to the structure. Activation may be done by known methods such as exposing the structure to an oxidizing agent such as steam, carbon dioxide, metal chloride (e.g., zinc chloride), potassium hydroxide, phosphoric acid, or potassium sulfide, at high temperatures (e.g., about 600° C. to about 1000° C.).

In order to provide a wall flow configuration as described herein, the methods of the present disclosure may further comprise selectively plugging at least one predetermined cell channel end with a plugging material to form a selectively plugged honeycomb structure. The selective plugging can be performed before carbonizing the honeycomb precursor composition or, alternatively, after the carbonization process or activation process is completed. In one or more embodiments, the plugging materials may be selected from those having similar shrinking rate with honeycombs during the carbonization process. Examples may include the same or similar honeycomb precursor composition used to form the honeycomb body, or a slightly modified composition comprising one or more synthetic cross-linked resins. In one or more embodiments, any material that can seal the cell channels 108 and sustain the desired application temperature (e.g., 150° C. to 300° C.) can be used. Examples may include UV-curable or thermally curable polymer resins such as phenolic resins and epoxy resins, thermal curable inorganic pastes such as Al₂O₃, SiO₂, TiO₂, ZrO₂ or a mixture thereof, and inorganic-organic hybrid materials that contain one or more UV-curable or thermally curable polymers and one or more inorganic compositions such as Al₂O₃, SiO₂, TiO₂, ZrO₂, Si, SiC, or carbon fiber. In addition, a cell channel size-matched solid with a thermal curable adhesive may also be used as the post-carbonization or activation process materials. The solid may be selected from materials that can sustain the desired application temperature (e.g., 150° C. to 300° C.), such as glass, wood, and polymer. The adhesive may again be any material or combination of materials mentioned above for plugging without the cell channel size-matched solid.

To accomplish the plugging process, a syringe may be used for dispensing an amount of plugging material into a desired cell channel 108. In another embodiment, a mask may be used to cover or block selective honeycomb cell channels 108 alternately and allow the plugging materials to be spread into the ends of the unmasked or uncovered channels. The syringe plugging and mask spreading plugging may be completed manually or using automated equipment. In one embodiment, the viscosity of the plugging materials may be adjusted to the range between 400 cP and 5000 cP to allow dispensing or spreading.

It should now be understood that honeycomb filters that include activated carbon with at least 1 wt. % of nitrogen may have enhanced performance characteristics, particularly with respect to carbon dioxide filtration and capture.

### EXAMPLES

Examples are provided herein which may disclose one or more embodiments of the present disclosure. However, the Examples should not be viewed as limiting on the claimed embodiments hereinafter provided.

### Example 1—Synthesis of Carbonized Aminophenol Resins

Aminophenol resins were prepared under basic conditions (pH 9-9.5) with methanol or water as the solvent as shown below in Chemical Formula A.

### Chemical Formula A

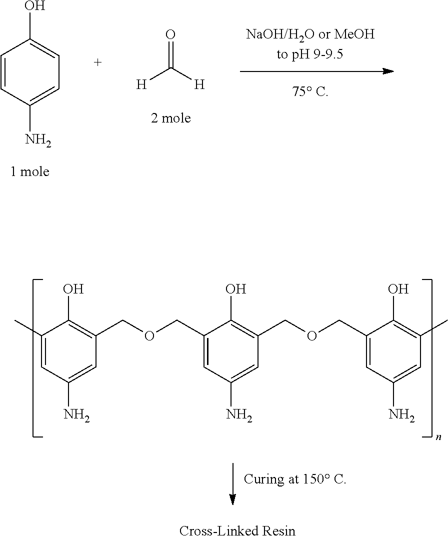

The ratio of aminophenol to formaldehyde used was 1:2. The mixture was heated to 75° C. for 2 hours. The resulting resin was then cross-linked at 150° C. The cross-linked aminophenol resins were carbonized at 1000° C. for 2 hours under nitrogen atmosphere. The carbonized carbon was further ground to 5 μm particle size. The cross-linking and carbonization yields for the aminophenol formaldehyde resins synthesized in methanol and water as solvents are listed in Table 1 below. The carbon, hydrogen, and nitrogen composition data for the formed aminophenol formaldehyde resins is shown in Table 2, below.

TABLE 1

| | Percent Solids after | Percent Yield after |
|---|---|---|
| | Curing (with Listed | Carbonization (with |
| Sample Name | Percent Error) | Listed Percent Error) |
| 3-aminophenol | 18 ± 2% | 56 ± 0.8% |
| formaldehyde in MeOH | | |
| 2-aminophenol | 17 ± 2% | 52 ± 0.8% |
| formaldehyde in MeOH | | |
| 4-aminophenol | 13 ± 0.5% | 60 ± 1% |
| formaldehyde in MeOH | | |
| 3-aminophenol | 29 ± 0.6% | 33 ± 0.4% |
| formaldehyde in Water | | |
| 4-aminophenol | 23 ± 1.7% | 50 ± 0.7% |
| formaldehyde in Water | | |

TABLE 2

| Sample Name | Carbon (wt. %) | Hydrogen (wt. %) | Nitrogen (wt. %) |
|---|---|---|---|
| 3-aminophenol | 59.51 | 1.11 | 8.41 |
| formaldehyde in | | | |
| Water | | | |
| 4-aminophenol | 51.46 | 1.13 | 11.41 |
| formaldehyde in | | | |
| Water | | | |
| 3-aminophenol | 75.85 | 1.43 | 9.52 |
| formaldehyde in | | | |
| MeOH | | | |
| 4-aminophenol | 90.85 | 1.05 | 3.56 |
| formaldehyde in | | | |
| MeOH | | | |

### Example 2—Synthesis of Carbonized Melamine Formaldehyde Resins

Melamine formaldehyde resins were synthesized according to Chemical Formula B below.

### Chemical Formula B

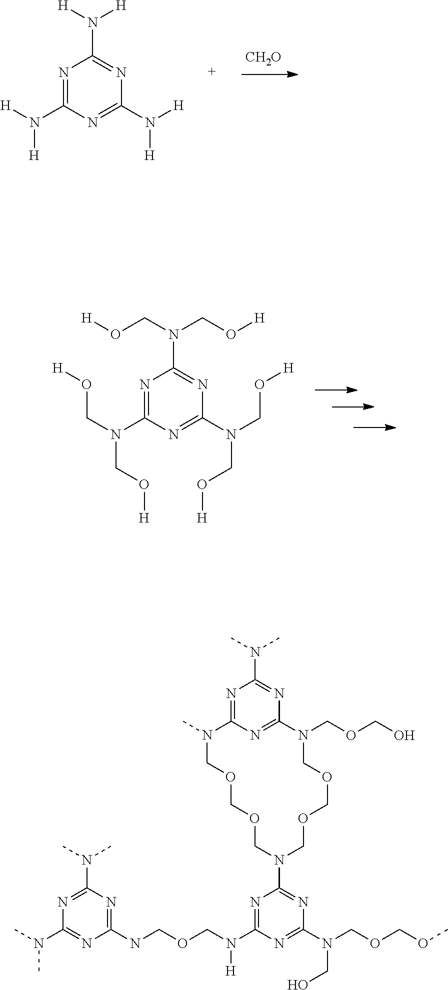

The ratio of 1:2 of melamine to formaldehyde was used to form the melamine formaldehyde resins. The mixture of melamine and formaldehyde was heated to 75° C. slowly to start the condensation reaction. The pH of the reaction mixture was maintained at 9 to avoid any cross-linking reaction under acidic conditions. The reaction mixture was stirred at 75° C. at pH 9 for 2 hours. A significant thickening of the reaction mixture was observed which suggests the progression of the condensation reaction. The condensation reaction for melamine and formaldehyde is shown below.

The synthesized melamine formaldehyde resin was cross-linked (cured) at 176° C. in the presence of para-toluene sulfonic acid (PTSA) as a catalyst. The melamine formaldehyde resin yields after curing and carbonization is listed below in Table 3 below.

TABLE 3

| | Percent | Percent |
|---|---|---|
| | Cross-Linking | Carbonization |
| | (with Listed | (with Listed |
| Sample Name | Percent Error) | Percent Error) |
| Melamine Formaldehyde | 76 ± 0.9% | 22 ± 0.6% |
| (No PTSA) | | |
| Melamine Formaldehyde | 48 ± 1.4% | 42 ± 0.6% |
| (0.02 mol PTSA/kg resin) | | |
| Melamine Formaldehyde | 72 ± 1.1% | 12 ± 1.0% |
| (0.04 mol PTSA/kg resin) | | |

The carbon prepared from cross-linking of melamine formaldehyde resin with 0.02 mol PTSA/kg resin showed the highest yield of carbon after carbonization (42%±0.6%). The cross-linked resin was carbonized at 1000° C. under nitrogen. The carbonized carbon was then ground to 5 μm particle size. The carbon was analyzed using elemental analysis as shown in Table 4 below.

TABLE 4

| | Carbon | Hydrogen | Nitrogen |
|---|---|---|---|
| Sample Name | (wt. %) | (wt. %) | (wt. %) |
| Melamine | 60.28 | 1.15 | 33.31 |
| Formaldehyde (No | | | |
| PTSA) | | | |
| Melamine | 57.85 | 1.36 | 37.20 |
| Formaldehyde (0.02 | | | |
| mol PTSA/kg resin) | | | |
| Melamine | 85.61 | Less than 0.1 | 11.61 |
| Formaldehyde (0.04 | | | |
| mol PTSA/kg resin) | | | |

Various grades of melamine formaldehyde resins were obtained from Hexion Specialty Chemicals. The details of the resins are listed in Table 5 below. Differences in viscosity and percent solids show that the resin synthesis processes were different.

TABLE 5

| Hexion Melamine | | | |
|---|---|---|---|
| Formaldehyde | Viscosity | Percent | |
| Resin | (cP) | of Solids | Shelf-Life |
| Astro Mel NW 3A | 600 | 80 | 4-6 months |
| Astro Mel 400 | 1000 | 82 | 6 months-1 year |
| Astro Mel 601 | 4000-5000 | 100 | More than 1 year |

The three different resins were optimized for cross-linking conditions (temperature and PTSA concentration) followed by carbonization. PTSA was added to the resin and stirred for 5 minutes before putting the resin in the oven at a designated temperature for cross-linking. Optimization of concentration of catalyst PTSA and cure temperature were carried out for each of these resins in the PTSA concentration range of 0 to 0.04 mol/kg and the temperature range evaluated was 150-200° C. The Hexion cross-linked resins were carbonized at 1000° C. for 2 hours under nitrogen atmosphere and ground to 5 μm particle size. The optimized Hexion NW 3 A resin gave the best yield of 64%±0.7% after crosslinking at 176° C. with 0.02 mol/kg of PTSA and 29%±2% after carbonization. Comparative data for the three Hexion resins is given below in Table 6.

TABLE 6

| | | | Percent | Percent Yield |
|---|---|---|---|---|
| Hexion | | | Recovery after | after |
| Melamine | Catalyst | Appearance | Cross-Linking | Carbonization |
| Formaldehyde | (PTSA 10% | after Cross- | (with Listed | (with Listed |
| Resin | solution) | Linking | Percent Error) | Percent Error) |
| Astro | 0.02 mol/kg of | Translucent | 64 ± 0.7% | 29 ± 2.0% |
| Mel NW 3A | resin | (with trapped | | |
| | | air bubbles). | | |
| | | The film was | | |
| | | strong. | | |
| Astro | 0.02 mol/kg of | Translucent | 68 ± 1.2% | 19 ± 1.9% |
| Mel 400 | resin | (with trapped | | |
| | | air bubbles). | | |
| | | The film was | | |
| | | strong. | | |
| Astro | 0.02 mol/kg of | Translucent | 74 ± 0.2% | 15 ± 2.0% |
| Mel 601 | resin | (with trapped | | |
| | | air bubbles). | | |
| | | The film was | | |
| | | slightly less | | |
| | | strong than the | | |
| | | other two | | |
| | | resins. | | |

The carbon, hydrogen, and nitrogen content was analyzed using elemental analysis as shown in Table 7.

TABLE 7

| | Carbon | Hydrogen | Nitrogen |
|---|---|---|---|
| Sample Name | (wt. %) | (wt. %) | (wt. %) |
| Astro NW 3A Resin | 62.67 | 1.23 | 31.19 |
| with 0.02 mol | | | |
| PTSA/kg of Resin | | | |
| Astro 400 Resin | 67.85 | 1.16 | 25.67 |
| with 0.02 mol | | | |
| PTSA/kg of Resin | | | |
| Astro 601 Resin | 87.29 | Less than 0.1 | 9.62 |
| with 0.02 mol | | | |
| PTSA/kg of Resin | | | |

### Example 3—Activation of Carbon Materials

5 grams of carbonized carbon was mixed with 10 grams of potassium hydroxide (KOH) in a silicon carbide crucible. The carbonized carbon-KOH mixture was then placed in a retort furnace. The furnace was flooded with nitrogen gas (flowrate˜62 L/min). The furnace was then ramped at 200° C./min to 900° C. and held at 900° C. for 4 hours under nitrogen atmosphere. The furnace was then cooled at furnace rate. The resulting activated carbon was then washed with water to neutral pH (7). The percent activation of the carbon after KOH activation for different precursors is given in Table 8 below.

TABLE 8

| | Percent Activation (with |
|---|---|
| Sample Name | Listed Percent Error) |
| Hexion Astro NW 3A Melamine | 45 ± 1.3% |
| Formaldehyde Resin | |
| Corning Internal Melamine Formaldehyde | 29 ± 2.1% |
| Resin | |
| 4-aminophenol Formaldehyde Resin | 58 ± 0.4% |

### Example 4—Testing of Activated Carbon Materials for CO₂ Adsorption

Surface area and pore volume data and CO₂ adsorption data on various activated carbons is given in Table 9 below.

TABLE 9

| | | | CO₂ Volume | CO₂ Volume |
|---|---|---|---|---|
| | Surface | Pore | Adsorbed in | Adsorbed in |
| | Area | Volume | mol/kg at | mol/kg at |
| Sample Name | (m²/g) | (cm³/g) | 45 bar | 1 bar |
| Hexion NW 3A | 1015.38 ± 50.76 | 0.37 ± 0.01 | 12.38 ± 0.24 | 3.06 ± 0.15 |
| Melamine | | | | |
| Formaldehyde | | | | |
| Resin Carbon | | | | |
| Corning Internal | 1203.12 ± 36.09 | 0.28 ± 0.01 | 12.04 ± 0.12 | 2.77 ± 0.11 |
| Melamine | | | | |
| Formaldehyde | | | | |
| Resin Carbon | | | | |
| 4-aminophenol | 1910.21 ± 38.20 | 0.15 ± 0.01 | 17.1 ± 0.17 | 3.71 ± 0.18 |
| Formaldehyde | | | | |
| Resin Carbon | | | | |

The present disclosure includes one or more non-limiting aspects. A first aspect includes a honeycomb filter comprising a porous honeycomb body comprising activated carbon, the porous honeycomb body having a plurality of parallel cell channels bounded by porous channel walls traversing the porous honeycomb body from an upstream inlet end to a downstream outlet end, wherein: the activated carbon is dispersed throughout the porous channel walls; and the activated carbon comprises from 1 wt. % to 50 wt. % nitrogen based on the total weight of the activated carbon.

A second aspect includes any above aspect, wherein the activated carbon comprises from 10 wt. % to 50 wt. % nitrogen based on the total weight of the activated carbon.

A third aspect includes any above aspect, wherein the activated carbon comprises from 15 wt. % to 50 wt. % nitrogen based on the total weight of the activated carbon.

A fourth aspect includes any above aspect, wherein the activated carbon comprises from 20 wt. % to 50 wt. % nitrogen based on the total weight of the activated carbon.

A fifth aspect includes any above aspect, wherein the activated carbon is formed from processing a cross-linked resin.

A sixth aspect includes any above aspect, wherein one or more of the parallel cell channels comprise an end plug sealed to the porous channel walls bounding the one or more cell channels to form one or more end plugged parallel cell channels.

A seventh aspect includes any above aspect, wherein the porous honeycomb body further comprises an inorganic filler.

An eighth aspect includes a method of adsorbing carbon dioxide, the method comprising passing a gas comprising carbon dioxide through one or more of the plurality of parallel cell channels of the honeycomb filter of any above aspect, wherein at least a portion of the gas passes through one or more of the porous channel walls and at least a portion of the carbon dioxide from the gas is adsorbed onto the one or more porous channel walls.

A ninth aspect includes a method of making a honeycomb filter, the method comprising forming a shapable honeycomb precursor composition comprising a cross-linked resin, wherein the cross-linked resin comprises from 0.5 wt. % to 4 wt. % nitrogen based on the total weight of the cross-linked resin; shaping the honeycomb precursor composition to form a honeycomb green body having a plurality of parallel cell channels bounded by porous channel walls traversing the honeycomb green body from an upstream inlet end to a downstream outlet end; heat treating the honeycomb green body to carbonize the cross-linked resin and form a carbonized honeycomb green body; and activating the carbonized honeycomb green body to produce the honeycomb filter comprising an activated carbon honeycomb body having a plurality of parallel cell channels bounded by porous channel walls traversing the body from an upstream inlet end to a downstream outlet end, wherein the activated carbon honeycomb body comprises activated carbon comprising from 1 wt. % to 50 wt. % nitrogen based on the total weight of the activated carbon.

A tenth aspect includes any above aspect, wherein the cross-linked resin comprises an aminophenol-based resin, a melamine-based resin, a nitrophenol-based resin, or combinations thereof.

An eleventh aspect includes any above aspect, wherein heat treating the honeycomb green body comprises heating the honeycomb green body to a temperature of from 600° C. to 1,200° C. for from 1 hour to 10 hours at an inert atmosphere.

A twelfth aspect includes any above aspect, wherein activating the carbonized honeycomb green body comprises contacting the carbonized honeycomb green body with an oxidizing agent at a temperature of from 600° C. to 1,000° C.

A thirteenth aspect includes any above aspect, wherein the oxidizing agent comprises potassium hydroxide, carbon dioxide, steam, or combinations thereof.

A fourteenth aspect includes a honeycomb filter, wherein the honeycomb filter is synthesized by the method of any above aspect.

A fifteenth aspect includes a method of making a honeycomb filter, the method comprising forming a honeycomb precursor composition comprising a cross-linked resin, wherein the cross-linked resin comprises from 0.5 wt. % to 4 wt. % nitrogen based on the total weight of the cross-linked resin; heat treating the honeycomb precursor composition to carbonize the cross-linked resin and form a carbonized honeycomb precursor composition; activating the carbonized honeycomb precursor composition to produce an activated honeycomb precursor composition; and shaping the activated honeycomb precursor composition to form the honeycomb filter comprising an activated carbon honeycomb body having a plurality of parallel cell channels bounded by porous channel walls traversing the body from an upstream inlet end to a downstream outlet end, wherein the activated carbon honeycomb body comprises activated carbon comprising from 1 wt. % to 50 wt. % nitrogen based on the total weight of the activated carbon.

A sixteenth aspect includes any above aspect, wherein the cross-linked resin is an aminophenol-based resin, a melamine-based resin, a nitrophenol-based resin, or combinations thereof.

A seventeenth aspect includes any above aspect, wherein heat treating the honeycomb precursor composition comprises heating the honeycomb precursor composition to a temperature of from 600° C. to 1.200° C. for from 1 hour to 10 hours at an inert atmosphere.

An eighteenth aspect includes any above aspect, wherein activating the carbonized honeycomb precursor composition comprises contacting the carbonized honeycomb precursor composition with an oxidizing agent at a temperature of from 600° C. to 1,000° C.

A nineteenth aspect includes any above aspect, wherein the oxidizing agent comprises potassium hydroxide, carbon dioxide, steam, or combinations thereof.

A twentieth aspect includes a honeycomb filter, wherein the honeycomb filter is synthesized by the method of any above aspect.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

For the purposes of describing and defining the present inventive technology, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It should be understood that any two quantitative values assigned to a property may constitute a range of that property, and all combinations of ranges formed from all stated quantitative values of a given property are contemplated herein.

What is claimed is:

1. A honeycomb filter comprising:
a porous honeycomb body comprising activated carbon, the porous honeycomb body having a plurality of parallel cell channels bounded by porous channel walls traversing the porous honeycomb body from an upstream inlet end to a downstream outlet end, wherein:
the activated carbon is dispersed throughout the porous channel walls; and
the activated carbon comprises from 1 wt. % to 50 wt. % nitrogen based on the total weight of the activated carbon.

2. The honeycomb filter of claim 1, wherein the activated carbon comprises from 10 wt. % to 50 wt. % nitrogen based on the total weight of the activated carbon.

3. The honeycomb filter of claim 1, wherein the activated carbon comprises from 15 wt. % to 50 wt. % nitrogen based on the total weight of the activated carbon.

4. The honeycomb filter of claim 1, wherein the activated carbon comprises from 20 wt. % to 50 wt. % nitrogen based on the total weight of the activated carbon.

5. The honeycomb filter of claim 1, wherein activated carbon is formed from processing a cross-linked resin.

6. The honeycomb filter of claim 1, wherein one or more of the parallel cell channels comprise an end plug sealed to the porous channel walls bounding the one or more cell channels to form one or more end plugged parallel cell channels.

7. The honeycomb filter of claim 1, wherein the porous honeycomb body further comprises an inorganic filler.

8. A method of adsorbing carbon dioxide, the method comprising passing a gas comprising carbon dioxide through one or more of the plurality of parallel cell channels of the honeycomb filter of claim 1, wherein at least a portion of the gas passes through one or more of the porous channel walls and at least a portion of the carbon dioxide from the gas is adsorbed onto the one or more porous channel walls.

9. A method of making a honeycomb filter, the method comprising:
forming a shapable honeycomb precursor composition comprising a cross-linked resin, wherein the cross-linked resin comprises from 0.5 wt. % to 4 wt. % nitrogen based on the total weight of the cross-linked resin;
shaping the honeycomb precursor composition to form a honeycomb green body having a plurality of parallel cell channels bounded by porous channel walls traversing the honeycomb green body from an upstream inlet end to a downstream outlet end;
heat treating the honeycomb green body to carbonize the cross-linked resin and form a carbonized honeycomb green body; and
activating the carbonized honeycomb green body to produce the honeycomb filter comprising an activated carbon honeycomb body having a plurality of parallel cell channels bounded by porous channel walls traversing the body from an upstream inlet end to a downstream outlet end,
wherein the activated carbon honeycomb body comprises activated carbon comprising from 1 wt. % to 50 wt. % nitrogen based on the total weight of the activated carbon.

10. The method of claim 9, wherein the cross-linked resin comprises an aminophenol-based resin, a melamine-based resin, a nitrophenol-based resin, or combinations thereof.

11. The method of claim 9, wherein heat treating the honeycomb green body comprises heating the honeycomb green body to a temperature of from 600° C. to 1,200° C. for from 1 hour to 10 hours at an inert atmosphere.

12. The method of claim 9, wherein activating the carbonized honeycomb green body comprises contacting the carbonized honeycomb green body with an oxidizing agent at a temperature of from 600° C. to 1,000° C.

13. The method of claim 12, wherein the oxidizing agent comprises potassium hydroxide, carbon dioxide, steam, or combinations thereof.

14. A honeycomb filter, wherein the honeycomb filter is synthesized by the method of claim 9.

15. A method of making a honeycomb filter, the method comprising:
forming a honeycomb precursor composition comprising a cross-linked resin, wherein the cross-linked resin comprises from 0.5 wt. % to 4 wt. % nitrogen based on the total weight of the cross-linked resin;
heat treating the honeycomb precursor composition to carbonize the cross-linked resin and form a carbonized honeycomb precursor composition;
activating the carbonized honeycomb precursor composition to produce an activated honeycomb precursor composition; and
shaping the activated honeycomb precursor composition to form the honeycomb filter comprising an activated carbon honeycomb body having a plurality of parallel cell channels bounded by porous channel walls traversing the body from an upstream inlet end to a downstream outlet end,
wherein the activated carbon honeycomb body comprises activated carbon comprising from 1 wt. % to 50 wt. % nitrogen based on the total weight of the activated carbon.

16. The method of claim 15, wherein the cross-linked resin is an aminophenol-based resin, a melamine-based resin, a nitrophenol-based resin, or combinations thereof.

17. The method of claim 15, wherein heat treating the honeycomb precursor composition comprises heating the honeycomb precursor composition to a temperature of from 600° C. to 1,200° C. for from 1 hour to 10 hours at an inert atmosphere.

18. The method of claim 15, wherein activating the carbonized honeycomb precursor composition comprises contacting the carbonized honeycomb precursor composition with an oxidizing agent at a temperature of from 600° C. to 1,000° C.

19. The method of claim 18, wherein the oxidizing agent comprises potassium hydroxide, carbon dioxide, steam, or combinations thereof.

20. A honeycomb filter, wherein the honeycomb filter is synthesized by the method of claim 15.
